(19) United States
(12) Patent Application Publication
(10) Pub. No.: US 2026/0160274 A1
(43) Pub. Date: Jun. 11, 2026

(54) Fan

(71) Applicant: MAHLE International GmbH, Stuttgart (DE)

(72) Inventor: Florian Mayot, Tiefenau (DE)

(21) Appl. No.: 19/415,289

(22) Filed: Dec. 10, 2025

(30) Foreign Application Priority Data
Dec. 11, 2024 (DE) 102024137152.8

(51) Int. Cl. F04D 29/66; B60H 1/24; F04D 29/32

(52) U.S. Cl. CPC F04D 29/666; B60H 1/24; F04D 29/325

(57) ABSTRACT

A fan that has a fan wheel with blades, and an outer ring encircling the fan wheel are provided.

The fan wheel has a ring encircling the ends of the blades,
the fan wheel ring has an outer surface and the outer ring has an inner surface,
the outer surface is opposite the inner surface,
there is a raised contour on the inner surface of the outer ring facing the outer surface of the fan wheel ring.

### CROSS-REFERENCE TO RELATED APPLICATIONS

This application claims priority from German Patent Application No. 102024137152.8, filed on Dec. 11, 2024, the entirety of which is hereby incorporated by reference herein.

The present invention relates to a fan that has a fan wheel with blades and an outer ring encircling the fan wheel, as set forth in Numbered Paragraph 1. The invention also relates to an air conditioner for a motor vehicle that has such a fan.

Fans have many uses in vehicles, e.g. in the air conditioner for the passenger compartment, and for cooling motors. Fan wheels with a ring on the outer ends of the blades result in more rigid and effective fans, which are also quieter. The outer ends of the individual blades are permanently attached to this ring. The fan wheel is surrounded in a frame with an outer ring to which the motor for the fan is also attached.

The disadvantage with fans from the prior art is that turbulence may be generated between the ring on the fan wheel and the outer ring, which not only lowers the efficiency of the fan, but also makes it louder.

The present invention addresses the problem of finding a better, or at least different, design for a fan with which the problems from the prior art can be resolved.

This problem is solved by the subject matter of Numbered Paragraph 1. Advantageous embodiments of the invention are the subject matter of the dependent Numbered Paragraphs.

The present invention is based on the general idea of designing the outer surface of the fan wheel ring and the inner surface of the outer ring such that turbulence is at least reduced between these surfaces and preferably even eliminated, not only increasing the efficiency of the fan, but also making it quieter. This fan has a fan wheel with blades, the outer ends of which are encircled and secured in place by a ring. The fan also has a frame with an outer ring that encircles the fan wheel. The fan wheel ring has an outer surface and the outer ring has an inner surface with a raised contour facing the outer surface on the fan wheel ring. This contour at least reduces, if not fully eliminates, the turbulence, and therefore the noise, between the rings. This fan is therefore not only more efficient, but also quieter.

In an advantageous design, the fan wheel ring has a collar on the upstream edge facing into the oncoming airflow, forming a corner on the ring at the edge of the outer surface of the ring. The outer ring has a substantially complimentary contour at the edge of the inner surface that lies opposite the first edge on the fan wheel ring. This forms a kind of seal in the form of a labyrinth, that at least reduces the turbulence generated when the fan is in use.

With the fan obtained with the invention, the inner surface on the outer ring has an axial length ZW. This axial length can be between 14 and 18 mm. This results in a relatively long axial gap between the fan wheel ring and the outer ring. There can also be a radial spacing GH between the inner surface of the outer ring and the outer surface of the fan wheel ring, e.g. 6 mm. This allows the fan wheel to rotate without coming in contact with the outer ring, despite the gap being relatively small, which at least reduces undesired turbulence.

In a particularly preferred design of the fan, an axial length RZ2 of the raised contour satisfies the following condition:

$${0.15}^{*} ZW < RZ 2 < {0.4}^{*} ZW .$$

The radial spacing GH between the inner surface of the outer ring and the outer surface of the fan wheel ring can be further reduced by the axial length RZ2 of the raised contour in relation to the axial length ZW of the inner surface of the outer ring in this area, forcing backflow to flow around the contour. This reliably prevents turbulence there. The backflow can then continue to flow through the entire radial spacing GH between the inner surface of the outer ring and the outer surface of the fan wheel ring without resulting in turbulence. The axial length RZ2 of the contour is only a fraction of the axial length ZW of the inner surface of the outer ring.

In another advantageous design of the fan obtained with the invention, the radial height RZ3 of the contour satisfies the following condition:

$${0.05}^{*} GH < RZ 3 < {0.4}^{*} GH .$$

In concrete terms, this means that the radial height is between 5 and 49% of the radial spacing GH between the inner surface of the outer ring and the outer surface of the fan wheel ring. As a result of the relatively low radial height RZ3 a backflow can be obtained for pressure compensation. By forcing the backflow around the contour, the turbulence, and therefore the noise, normally generated in this space are at least reduced, and preferably eliminated.

In another advantageous design of the fan obtained with the invention, the distance RZ1 from the contour to the upstream edge of the inner surface of the outer ring satisfies the following condition:

$${0.03}^{*} ZW < RZ 1 < {0.3}^{*} ZW .$$

In concrete terms, this means that the contour on the outer ring is near the upstream edge, which is precisely where turbulence occurs in other fans. By only placing the contour here, air is forced to flow around it, reducing noise and increasing the efficiency of the fan. “The upstream edge” in this case relates to the direction of the backflow.

In another advantageous design of the fan obtained with the invention, the contour is an integral part of the outer ring, formed in particular in a plastic injection molding process.

This contour can be obtained by simply modifying the injection molding tool. It should be clear that this contour entirely encircles the outer ring. By forming the contour as an integral part of the outer ring, both the outer ring and the contour can be produced simply, precisely, and inexpensively. It would also be possible to produce the contour separately, and subsequently attach it to the outer ring, e.g. with an adhesive. This offers greater possibilities in terms of the design, which can be tailored to specific applications.

In another advantageous design of the fan obtained with the invention, the upstream and downstream sides of the contour are at an angle to the inner surface. This reduces percussive flows, because the angled surface functions as a guide, conducting the backflow around the contour. “The upstream and downstream sides” refer to the backflow direction, which is counter to the main direction in which the air is flowing.

In another advantageous design of the fan obtained with the invention, the inner surface of the outer ring is parallel to the outer surface of the fan wheel ring. This results in a substantially parallel gap between the outer surface and the inner surface. The first edge on the collar can also be parallel to the second edge on the outer ring. This results in a substantially rectangular channel between the outer ring and the fan wheel, forming a type of labyrinth seal that at least reduces undesired backflow.

The present invention is also based on the general idea of equipping an air conditioner for a motor vehicle with the fan described above, which then has the same advantages as the fan. These advantages include a more effective performance, and a more efficient fan, which are particularly advantageous when used in an electric vehicle, which is much more sensitive to noises.

Other important features and advantages of the invention can be derived from the dependent Numbered Paragraphs, the drawings, and the descriptions of the drawings.

It is understood that the features specified above and explained below can be used not only in the given combinations, but also in other combinations or in and of themselves, without abandoning the scope of the invention. Parts of a unit, e.g. an assembly, apparatus, or device, that are referred to separately may be independent components, or form components of this unit, or they may be integral parts or sections of this unit, even if the drawings indicate otherwise.

Preferred exemplary embodiments of the invention are illustrated in the drawings and shall be described in greater detail below, in which the same reference symbols are used for the same, similar, or functionally identical components.

Therein, schematically:

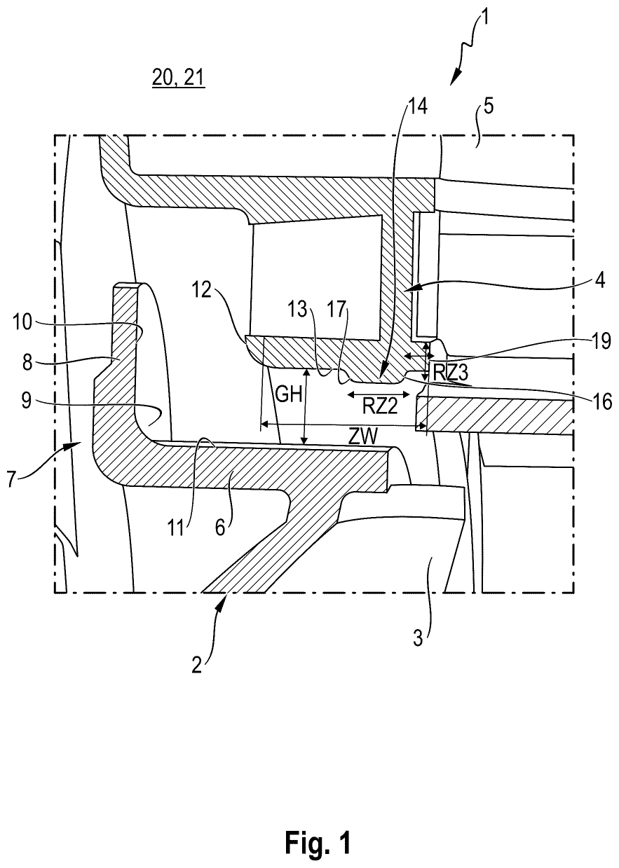

FIG. 1 shows a sectional view of a fan obtained with the invention,

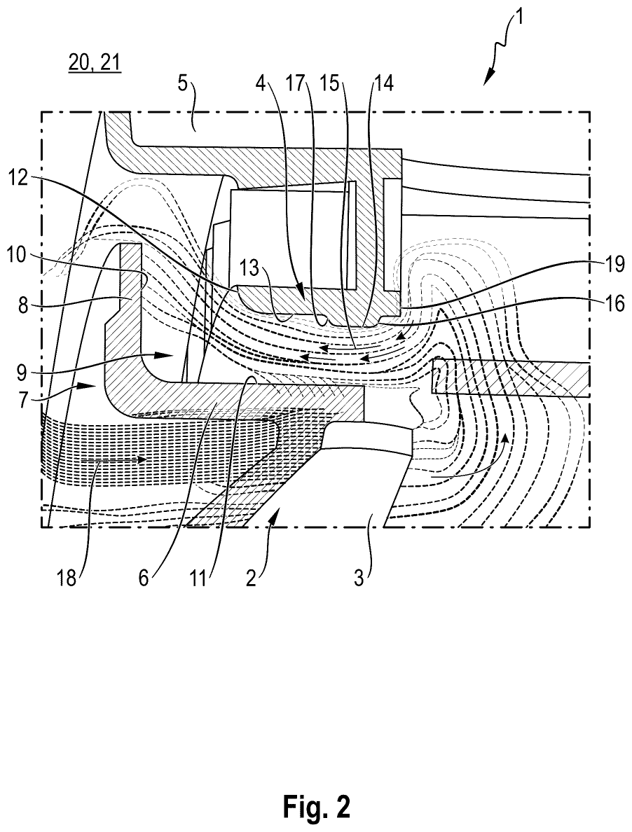

FIG. 2 shows that in FIG. 1, but with a simulated airflow when the fan is in use.

The fan 1 shown in FIGS. 1 and 2 has a fan wheel 2 with blades 3 and an outer ring 4 encircling the fan wheel 2. This outer ring 4 is part of a frame 5. The fan wheel 2 also has a ring 6 with a collar 8 on the upstream edge 7, which forms a corner 9 where the collar 8 meets the ring 6 that has a first edge 10 and an outer surface 11. The upstream edge 7 in this case relates to the direction of the main airflow 18. The outer ring 4 has a contour that is substantially complimentary to this corner, which has a second edge 12 and an inner surface 13. The first edge 10 lies opposite the second edge 12, and the outer surface 11 lies opposite the inner surface 13. A raised contour 14 is formed on the inner surface 13 of the outer ring 4, facing toward the outer surface 11 of the fan wheel ring 6. This is where turbulence was generated in the prior art, without this contour 14, not only impacting the performance or efficacy of the fan 1, but also generating noise. This contour 14 prevents turbulence in this area, as can be seen in FIG. 2.

The contour 14 can be formed as an integral part of the outer ring 4, in particular in an injection molding process, resulting in a contour 14 that can be produced inexpensively and easily. The contour 14 could also be produced separately, and subsequently attached to the outer ring 4, e.g. with an adhesive.

In a closer examination of the contour 14 shown in FIGS. 1 and 2, it can be seen that it has an upstream side 16 and a downstream side 17, which are both angled in relation to the inner surface 13. Consequently, the backflow 15 can be diverted around the contour 14, particularly at the upstream side 16, thus generating little noise, in a streamlined manner. The backflow 15 is counter to the main flow 18, generated through the rotation of the fan wheel 2.

FIGS. 1 and 2 also show that the inner surface 13 is parallel to the outer surface 11, resulting in a channel with nearly parallel walls between the outer ring 4 and the ring 6 on the fan wheel 2. The first edge 10 and second edge 12 can also be parallel, diverting the backflow 15 in the corner 9, thus forming a type of labyrinth seal.

The inner surface 13 of the outer ring 4 has an axial length ZW in relation to the rotational axis of the fan 1, running from left to right in FIGS. 1 and 2. The radial distance GH between the inner surface 13 of the outer ring 4 and the outer surface 11 of the fan wheel ring 6 is ca. 6 mm.

The axial length RZ2 of the contour 14 in the fan obtained with the invention satisfies the following condition:

$${0.15}^{*} ZW < RZ 2 < {0.4}^{*} ZW .$$

The axial length RZ2 is measured at the base of the contour 14, and is shorter on its exposed surface due to the angled upstream and downstream sides 16, 17.

The radial height RZ3 of the contour 14 satisfies the following condition in the fan 1 obtained with the invention:

$${0.05}^{*} GH < RZ 3 < {0.4}^{*} GH .$$

This means that the radial height RZ3 of the contour 14 is ca. 5-40% of the spacing GH between the inner surface 14 on the outer ring 4 and the outer surface 11 on the fan wheel ring 6. This limited radial height RZ3 is already sufficient to eliminate, or at least reduce turbulence in this area that would otherwise impact the performance of the fan, and make it louder, if there were no contour 14.

FIG. 1 also shows that the distance RZ1 from the contour 14 to the upstream edge 19 of the inner surface 13 of the outer ring 4 satisfies the following condition:

$${0.03}^{*} ZW < RZ 1 < {0.3}^{*} ZW .$$

This means that the distance from the contour 14 to the upstream edge 19 of the inner surface 13 is between 3 and 13% of the axial length ZW of the inner surface 13, and is therefore displaced to the right in FIGS. 1 and 2, i.e. it is off-center on the inner surface 13.

This fan 1 can be part of an air conditioner 20 in a motor vehicle 21.

On the whole, the fan 1 is much quitter in the fan 1 and air conditioner 20 obtained with the invention, because the contour 14 on the inner surface 13 of the outer ring 4 prevents, or at least reduces, the turbulence previously generated in this area. This also improves the efficiency and efficacy of the fan 1, and therefore, indirectly, that of the air conditioner 2. In particular, this lowers power consumption in an electric vehicle 21, thus increasing travel range.

The specification can be readily understood with reference to the following Numbered Paragraphs:
Numbered Paragraph 1. A fan (1) that has a fan wheel (2) with blades (3) and an outer ring (4) encircling the fan wheel (2), characterized in that
   the fan wheel (2) has a ring (6) encircling the ends of the blades (3),
   the fan wheel ring (6) has an outer surface (11) and the outer ring (4) has an inner surface (13),
   the outer surface (11) is opposite the inner surface (13),
   there is a raised contour (14) on the inner surface (13) of the outer ring (4) facing the outer surface (11) of the fan wheel ring (6).
Numbered Paragraph 2. The fan (1) according to Numbered Paragraph 1, characterized in that
   there is a collar (8) on the upstream edge (7) of the fan wheel ring (6),
   the fan wheel ring (6) and the collar (8) form a corner (9) where they meet, that has a first edge (10) delimiting the outer surface (11),
   the outer ring (4) has a contour that is substantially complimentary to this corner (9), which has a second edge (12) and the inner surface (13),
   the first edge (10) is opposite the second edge (12).
Numbered Paragraph 3. The fan (1) according to Numbered Paragraph 1 or 2, characterized in that
   the inner surface (13) of the outer ring (4) has an axial length ZW, and
   the radial spacing GH between the inner surface (13) and outer surface (11) is ca. 6 mm.
Numbered Paragraph 4. The fan (1) according to Numbered Paragraph 1, characterized in that the axial length RZ2 of the raised contour (14) satisfies the following condition:

$${0.15}^{*} ZW < RZ 2 < {0.4}^{*} ZW .$$

Numbered Paragraph 5. The fan (1) according to Numbered Paragraph 3 or 4, characterized in that the radial height RZ3 of the raised contour (14) satisfies the following condition:

$${0.05}^{*} GH < RZ 3 < {0.4}^{*} GH .$$

Numbered Paragraph 6. The fan (1) according to any of the Numbered Paragraphs 3 to 5, characterized in that the distance RZ1 from the contour (14) to the upstream edge (19) of the inner surface (13) of the outer ring (4) satisfies the following condition:

$${0.03}^{*} ZW < RZ 1 < {0.3}^{*} ZW .$$

Numbered Paragraph 7. The fan (1) according to any of the preceding Numbered Paragraphs, characterized in that the contour (14) is formed as an integral part of the outer ring (4), in particular in an injection molding process.
Numbered Paragraph 8. The fan (1) according to any of the preceding Numbered Paragraphs, characterized in that the upstream side (16) and downstream side (17) of the contour (14) are angled in relation to the inner surface (13).
Numbered Paragraph 9. The fan (1) according to any of the Numbered Paragraphs 2 to 8, characterized in that
   the inner surface (13) is parallel to the outer surface (11), and/or
   the first edge (10) is parallel to the second edge (12).
Numbered Paragraph 10. An air conditioner (20) for a motor vehicle (21) that has a fan (1) according to any of the preceding Numbered Paragraphs.

List of Reference Symbols

| | |
|---|---|
| 1 | fan wheel |
| 2 | fan |
| 3 | blade |
| 4 | outer ring |
| 5 | frame |
| 6 | fan wheel ring |
| 7 | upstream side |
| 8 | collar |
| 9 | corner |
| 10 | first edge |
| 11 | outer surface |
| 12 | second edge |
| 13 | inner surface |
| 14 | contour |
| 15 | flow |
| 16 | upstream side |
| 17 | downstream side |
| 18 | main flow |
| 19 | upstream edge of the inner surface 13 |
| 20 | air conditioner |
| 21 | motor vehicle |

1-10. (canceled)

11. A fan, comprising: a fan wheel with a plurality of blades and an outer ring encircling the fan wheel, wherein
the fan wheel comprises a ring encircling the ends of each of the plurality of blades,
the fan wheel ring has an outer surface and the outer ring has an inner surface, and
the outer surface is opposite the inner surface,
further comprising a raised contour on the inner surface of the outer ring facing the outer surface of the fan wheel ring.

12. The fan according to claim 11, further comprising a collar on the upstream edge of the fan wheel ring, wherein the fan wheel ring and the collar form a corner where they meet, that has a first edge delimiting the outer surface,
wherein the outer ring has a contour that is substantially complimentary to this corner, which has a second edge and the inner surface,
wherein the first edge is opposite the second edge.

13. The fan according to claim 11, wherein the inner surface of the outer ring has an axial length (ZW) that is between 14 mm and 18 mm, and the radial spacing (GH) between the inner surface and outer surface is about 6 mm.

14. The fan according to claim 11, wherein the axial length (RZ2) of the raised contour satisfies the following condition:
$${0.15}^{*} ZW < RZ 2 < {0.4}^{*} ZW .$$

15. The fan according to claim 13, wherein the radial height (RZ3) of the raised contour satisfies the following condition:
$${0.05}^{*} GH < RZ 3 < {0.4}^{*} GH .$$

16. The fan according to claim 13, wherein the distance (RZ1) from the contour to the upstream edge (19) of the inner surface of the outer ring satisfies the following condition:
$${0.03}^{*} ZW < RZ 1 < {0.3}^{*} ZW .$$

17. The fan according to claim 11, wherein the contour is formed as an integral part of the outer ring.

18. The fan according to claim 11, wherein the upstream side and downstream side of the contour are angled in relation to the inner surface.

19. The fan according to claim 12, wherein the inner surface is parallel to the outer surface, and/or the first edge is parallel to the second edge.

20. An air conditioner for a motor vehicle that has a fan according to claim 10.
